(19) United States
(12) Patent Application Publication
(10) Pub. No.: US 2022/0094664 A1
(43) Pub. Date: Mar. 24, 2022

(54) METHOD AND SYSTEM TO ENHANCE COMMUNICATION BETWEEN AN IPV6-ONLY SIP CLIENT AND AN IPV4-ONLY SERVER OR CLIENT

(71) Applicant: Avaya Management L.P., Santa Clara, CA (US)

(72) Inventor: Dusan Mudric, Ottawa (CA)

(21) Appl. No.: 17/030,010

(22) Filed: Sep. 23, 2020

(51) Int. Cl. H04L 29/12; H04L 29/06

(52) U.S. Cl. CPC H04L 61/251; H04L 61/1511; H04L 69/22; H04L 65/608; H04L 65/1006

(57) ABSTRACT

Systems, methods, software and apparatus to enhance connectivity to an IPv6-only SIP client and an IPv4-only server and/or client. In one embodiment, a method comprises assigning the IPv6-only client an IPv4-translatable IPv6 Internet Protocol (IP) address. The method further includes determining the IPv6-only client is initiating the SIP communication session with the IPv4-only server or client. The method further includes extracting an IPv4 IP address from the IPv4 translatable IPv6 IP address, and using the extracted IPv4 address in a SIP contact header to register with an IPv4 SIP server and the Via header to get 200 OK responses. The IPv4 address used in the ‘c’ or ‘m’ lines is used to synthesize an IPv4 translatable IPv6 address for directly transferring media between an IPv6-only client and an IPv4-only client.

### FIELD OF THE DISCLOSURE

The present disclosure is generally directed toward communications and more particularly toward enhancing connectivity for IPv6-only SIP clients in communications with IPv4-only SIP servers and clients.

### BACKGROUND

Communication devices are used for voice and video calling, video conferencing, gaming, Internet access, media streaming, data messaging, email, machine-to-machine data transfers, computerized information services, and the like. These services may be provided by applications running on the communication devices. The applications interact with application servers to provide their services. The communication devices may be phones, smartphones, computers, laptops, tablets, wearable devices, media players, intelligent machines, and the like. Devices may also communicate with other communication devices. In order to communicate with application servers and/or other devices, the applications and/or client devices transmit data over a network. A communication network uses various communication protocols to transmit data. The Internet uses protocols such as Internet Protocol version 4 (IPv4) and Internet Protocol version 6 (IPv6). A dual-stacked network is a network that allows devices to use both IPv4 and IPv6 to transmit data.

Communication networks use host names and/or domain names, which are resolved to one or more IP addresses to route traffic. For example, if a user wants to access the streaming video service NETFLIX®, the user may enter the domain name “netflix.com” into the address bar of the web browser application. The hostname “netflix.com” is stored along with IP address(es) of the host in a Domain Name Server (DNS). In other words, the DNS translates a domain name into an IP address. A domain name may resolve to multiple IP addresses. Each IP address may have different performance and/or connectivity characteristics. An IP address is a numerical label assigned to a device connected to an IP network. IPv4 define addresses using a 32-bit number (e.g., 192.16.254.1). IPv6 defines addresses using 128-bits (e.g., 2001:db8:0:1234:0:567:8:2). IPv6-only networks assign IPv6 prefixes and addresses that cannot be used to communicate with SIPv4 proxies. Previous solutions use a stateful NAT64 with DNS64 and an SBC running an application layer gateway (ALG) to enable IPv6-only SIP clients on IPv6-only networks to communicate with IPv4-only SIP servers and clients on IPv4 networks.

### SUMMARY

Embodiments of the present disclosure seek to enhance connectivity for IPv6-only clients in SIP sessions with IPv4-only servers and/or clients and allow for an IPv6-only SIP client to manage its own IPv4 service address and directly transfer media with an IPv4-only device. For example, an IPv6-only client may need to communicate with an IPv4-only server, or vice versa. In another example, an IPv6-only client may need to communicate with an IPv4-only client. Embodiments of the present disclosure include an IPv6-only client detecting that it is trying to communicate with an IPv4-only server and/or client. The IPv6-only client is assigned an IPv4-translatable IPv6 Internet Protocol (IP) address. The IPv6-only client extracts an IPv4 IP address from the IPv4 translatable IPv6 IP address, and uses the extracted IPv4 address in a SIP contact header of an IPv6 packet. When an IPv4 packet is sent from the IPv4-only client/server to the IPv6-only device, the IPv6 translation prefix is appended to the extracted IPv4 address and the IPv6 packet is routed to the IPv6-only device on the IPv6 network. Alternatively, when an IPv6 packet is sent from the IPv6-only client to the IPv4-only SIP Proxy, the translator removes the translation prefix from the TCP IPv6 addresses and the IPv4 packet is routed to the IPv4-only device on the IPv4 network. Additionally, an IPv6-only client will synthesize an IPv4 translatable IPv6 address for an RTP destination (e.g., direct media transfer).

Previously, IPv4-only servers and clients communicated with IPv6-only clients via a Border Relay (BR). The BR implements a Stateless IP/ICMP Translation (SIIT) algorithm, also known as Stateless NAT64. Stateless NAT64 provides a one-to-one IPv4-only to IPv6-only connection. The NAT64 functionality (which includes stateless translation) is enabled on both the BR IPv4 and the IPv6 uplink interfaces. The BR translates IPv4/ICMPv4 packet headers to IPv6/ICMPv6 packet headers, and vice versa, but does not keep per flow state. The SIIT algorithm maps an entire IPv4 address space into an IPv6 prefix from a service provider's address space. IPv4-only clients can reach IPv6-only clients using SIIT, using aggregated IPv4 service addresses. The IPv4-only client would send an invite to an IPv4 service address of the IPv6-only client, the BR maps the SIIT IPv4 service address into the IPv6-only client's IPv6 address using Explicit Address Mapping (EAM), or synthesizes an IPv6 address using an IPv4 service address and a NAT64 prefix.

The Dynamic Host Configuration Protocol version 6 (DHCPv6) is a network protocol for configuring Internet Protocol version 6 (IPv6) devices with IPv6 addresses, IP prefixes, and other configuration data required to operate in an IPv6 network. It is the IPv6 equivalent of the Dynamic Host Configuration Protocol for IPv4. IPv6-only networks assign IPv6-only clients IPv6 prefixes and addresses that cannot be used to communicate with a SIPv4 Proxy. For example, when an IPv6-only client (n6) needs to communicate with an IPv4-only server (s4), and the IPv6-only network is an enterprise network.

The IPv4 address for s4 is configured manually. A DNS client on the n6 is configured to receive an s4 AAAA record from the DNS46 server. Since the DNS46 knows the translation prefix, it can synthesize an AAAA record for the s4 server, which is used for the IPv6 service address for s4, when IPv6-only phones talks to s4. Since the IPv6-only client knows the translation prefix, when the IPv6-only client n6 receives the AAAA record for the IPv4-only s4 server, if the AAAA record starts with the translation prefix then IPv6-only client n6 knows it is communicating with an IPv4-only device on an IPv4-only network. The IPv4 addresses used are either public IPv4 addresses or addresses allocated for private networks. The IPv6 addresses used are either public IPv6 addresses or Unique Local Addresses (ULAs).

Organizations deploying stateless IPv4/IPv6 translation should assign a Network-Specific Prefix to their IPv4/IPv6 translation service. IPv4 translatable IPv6 address uses the selected Network-Specific Prefix. Both IPv4 translatable IPv6 addresses and IPv4 converted IPv6 addresses should use the same Prefix. The owner of the enterprise IPv6 network configures SIIT (Stateless IP/ICMP Translation) and DNS on the BR. In this example, the IPv6 prefix for stateless translation is chosen and configured on the SIIT translator (e.g. 2001:db8:46::/96). The translation prefix is used to create IPv4-embedded IPv6 addresses. The translation prefix should be taken from the operator's public IPv6 pool and be globally reachable.

The IPv6-only client n6 will be configured with an address from within the translation prefix subnet, and may use the address when establishing connections with native IPv6 destinations. The IPv4 prefix is allocated from the operator's public address pool (in this example, 192.0.2.0/24) and configured as a NAT64 route. The prefix subnet contains the IPv4 service addresses IPv4 clients will make connections to and that in turn will be translated to an IPv6 address. The gateway must also have a specific IPv6 route to the translated destination prefixes. In this example, a static route to 2001:db8:46:0:0:0:c000:3d00/96 (the translated equivalent of 192.0.2.0/24) to the uplink router.

Based on the default route translation prefix (e.g., 2001:db8:46:0:0:0:c000:3d00:/96 for SIIT), the packet reaches the SIIT translator on the providers BR. When an IPv6 packet is received on the BR, the IPv6 source address is host's IPv4-translatable IPv6 address. The destination IPv4 address is obtained by removing the NAT64 translation prefix from the IPv6 destination address. An IPv4 packet is routed to s4 using the IPv4 service address.

The IPv4-only server s4 responds with an IPv4 packet sent to SIIT using the IPv4 address. Destination IPv4 service addresses represent a node in the IPv6-only network. The destination IPv6 address for n6 is synthesized from the IPv4 destination address and NAT64 translation prefix. The source address (e.g., IPv6 synthesized address for s4) is obtained in the same manner. An IPv6 packet reaches the IPv6-only client n6. The source address for s4 is translated by means of the traditional prefix translation. The net result is that, from the organization's perspective, the whole IPv4 Internet is nothing more than just another network named “2001:db8:46:0:0:0:c000:3d00:196.”

SIP Via headers are used to allow SIP responses to follow the same path through the SIP proxies and application servers as the original requests. To remain on the signaling path for the SIP 200 OK responses, the client and servers insert their addresses in INVITE Via Headers. Assuming an IPv6-only host is registered with an IPv4-only proxy, the 200 OK cannot be routed from the SIPv4 Proxy back to the IPv6-only host. In the NAT64 translation, SIIT translation does not translate the IP addresses in the SIPv6 header and ‘c’ line to IPv6 addresses, so some kind of Application Layer Gateway (ALG) is required. For example, the ALG may be implemented in the BR or a Session Border Controller (SBC)

In some embodiments, the application may be trying to connect to the remote host using an IPv4 address. When an IPv6-only offeror in an IPv6-only network uses an IPv6 contact address to register with a SIP Proxy (single or dual mode) in an IPv4-only network (e.g., FIG. 3A), and the SIP Proxy sends an INVITE to the Contact IPv6 address over the IPv4-only network, the address cannot be routed to the NAT64 port. In other words, the n4 caller cannot reach the n6 callee. In another example, an IPv6-only caller (UA1) provides an IPv6 address as the Via header in the INVITE message (e.g., FIG. 3B). The SIP Proxy sends a 200 OK to the Via header IPv6 address over the IPv4-only network, and the address cannot be routed to NAT64 port (i.e., 200 OK from callee cannot reach the caller). With implementation of the present disclosure, the IPv6-only SIP client can detect it is in communication with an IPv4-only SIP server or client.

It is, therefore, one aspect of the present disclosure to provide a method of an IPv6-only client detecting it is attempting to communicate with an IPv4-only server or client, and register to the s4 server, extract an IPv4 address from an IPv4 translatable IPv6 IP address, and provide the extracted IPv4 address in the SIP contact header. A similar technique may be used to enable an IPv4-only SIP client to reach an IPv6-only server.

In some embodiments, an administrative user may configure the network to be single mode (e.g., IPv6-only). In some examples, the administrator may set a flag in the router(s) to indicate that the network is single mode. In some embodiments, the flag is a protected flag and is set using a setting file transferred using a secure protocol e.g., HTTPS). In other embodiments, the router may be configured to single-mode using a configuration or setting file. The router(s) configured to single-mode may then transfer a message to all connected to host(s), that the network is single-mode (e.g., IPv6-only). In other embodiments, some remote hosts may be accessible using one address family (e.g., IPv4 addresses only). For these hosts the client may perform Network Address Translation (NAT64). The IPv4 addresses may be converted into IPv6 addresses and accessed via an IPv6 socket. In some embodiments, IPv4-mapped IPv6 addresses are used as the last resort when an IPv4-only host is reachable only using IPv4 addresses. The host will try to find the IPv4-only Host on its local link using IPv4-mapped IPv6 address.

In other words, it is an aspect of the present disclosure to allow IPv6-only SIP clients on an IPv6-only network to communicate with IPv4-only SIP servers and/or clients on an IPv4-only network. In some embodiments, the communication session is a SIP communication session, and the present disclosure allows a client/host to use the proper IP address in the contact header.

Various embodiments and aspects of the embodiments are disclosed, including:

In some embodiments, a method is disclosed. The method generally comprises:

assigning the IPv6-only client an IPv4-translatable IPv6 Internet Protocol (IP) address;

determining the IPv6-only client is initiating the SIP communication session with the IPv4-only server or client;

extracting an IPv4 IP address from the IPv4 translatable IPv6 IP address; and

providing the extracted IPv4 address in a SIP header of IPv6 packets.

In another embodiment, an IPv6-only client is disclosed. The IPv6-only client that generally comprises:

a processor configured to determine the SIP communication session is with the IPv4-only server or client;

the processor configured to extract an IPv4 IP address from the IPv4-translatable IPv6 IP address; and

a communication interface configured to provide the extracted IPv4 IP address in a SIP header of IPv6 packet.

In a third embodiment, a computer-readable medium is disclosed. The computer-readable medium comprising processor-executable instructions comprising:

instructions configured to conduct a SIP (Session Initiation Protocol) communication session between an IPv6-only client and an IPv4-only server or client;

instructions configured to determine the IPv6-only client is initiating the SIP communication session with the IPv4-only server or client;

instructions configured to extract an IPv4 IP address from the IPv4-translatable IPv6 IP address; and

instructions configured to provide the extracted IPv4 IP address in a SIP header of IPv6 packets.

Aspects of any one or more of the foregoing embodiments include using the extracted IPv4 address in ‘m’ and ‘c’ SDP LINES to synthesize the IPv4-translatable IPv6 IP address, as an n4 IPv6 service address.

Aspects of any one or more of the foregoing embodiments include using the extracted IPv4 address in ‘m’ and ‘c’ SDP LINES as a destination Real-time Transport Protocol (RTP) address.

Aspects of any one or more of the foregoing embodiments include registering with a SIP IPv4-only Proxy using the extracted IPv4 IP address.

Aspects of any one or more of the foregoing embodiments include using the IPv4 translatable IPv6 IP address for TCP.

Aspects of any one or more of the foregoing embodiments include performing a DNS query for a SIPv4 Proxy FQDN and receiving AAAA records in response, wherein the AAAA records start with an IPv6 translation prefix.

Aspects of any one or more of the foregoing embodiments include determining a translation prefix; and extracting the IPv4 IP address from the IPv4 translatable IPv6 IP address using the determined translation prefix.

Aspects of any one or more of the foregoing embodiments include using the extracted IPv4 IP address in a Via header and a contact header.

Aspects of any one or more of the foregoing embodiments include the IPv6-only client and the IPv4-only server or client transmitting media directly using UDP.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram illustrating a single-mode and a dual-mode host in accordance with embodiments of the present disclosure;

FIGS. 2A-2B are block diagrams illustrating an IPv6-only device on an IPv6-only network communicating with an IPv4-only device on an IPv4-only network via a translator and SIP Proxy in accordance with embodiments of the present disclosure;

FIG. 3A illustrates an example message flow in which an IPv4-only caller cannot reach an IPv6-only callee in accordance with embodiments of the present disclosure;

FIG. 3B illustrates an example message flow in which the 200 OK message from the IPv4-only callee cannot reach the IPv6-only caller in accordance with embodiments of the present disclosure;

FIG. 3C illustrates an example message flow to establish a connection between the IPv6-only device on the IPv6-only network communicating with the IPv4-only device on the IPv4-only network in accordance with embodiments of the present disclosure;

FIG. 3D illustrates an example message flow to directly transfer media between the IPv6-only device on the IPv6-only network and the IPv4-only device on the IPv4-only network in accordance with embodiments of the present disclosure;

FIG. 4A is a flow diagram depicting the registration process implemented by a single mode client on a single mode network in accordance with embodiments of the present disclosure;

FIG. 4B is a flow diagram depicting the process implemented by a single mode client on a single mode network for direct media transfer in accordance with embodiments of the present disclosure FIG. 5 illustrates an example of an address translation table in accordance with embodiments of the present disclosure; and

FIG. 6 is a block diagram of a computer used to implement the method to enhance media path setup in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

It should be appreciated that embodiments of the present disclosure can be utilized in numerous address selection scenarios.

Furthermore, while the illustrative embodiments herein show the various components of a system collocated, it is to be appreciated that the various components of the system can be located at distant portions of a distributed network, such as a communication network and/or the Internet, or within a dedicated secure, unsecured, and/or encrypted system. Thus, it should be appreciated that the components of the system can be combined into one or more devices, such as an enterprise server or collocated on a particular node of a distributed network, such as an analog and/or digital communication network. As will be appreciated from the following description, and for reasons of computational efficiency, the components of the system can be arranged at any location within a distributed network without affecting the operation of the system. For example, the various components can be located in a local server, at one or more users' premises, or some combination thereof.

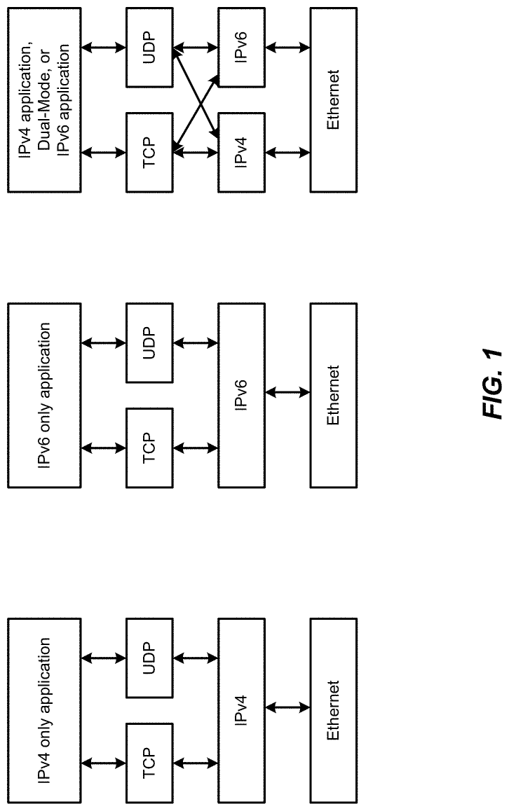

With reference initially to FIG. 1, the Internet is a set of connected ISPs, providing single mode (e.g., IPv4-only or IPv6-only) or dual-stacked network in which IPv4 and IPv6 operate in tandem. In other words, dual IPv4/IPv6 nodes may be reachable using IPv4 addresses, IPv6 addresses, or both. IPv4 addresses have a different format than IPv6 addresses, and the two formats are not compatible. Methods such as NAT and tunneling allow devices to communicate over networks of the opposite address family. Tunneling allows packets to be transmitted from one protocol to the other by encapsulating the packets of one protocol in packets of the other protocol. In other words, IPv6 packets are encapsulated in IPv4 packets to traverse IPv4-only network and vice versa.

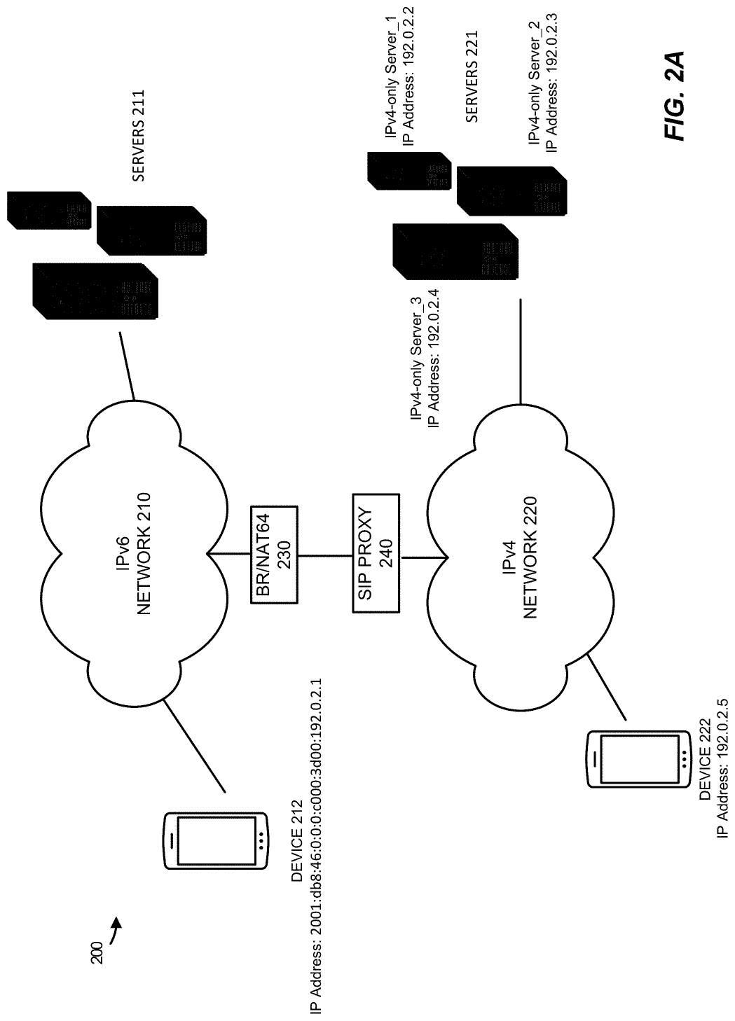

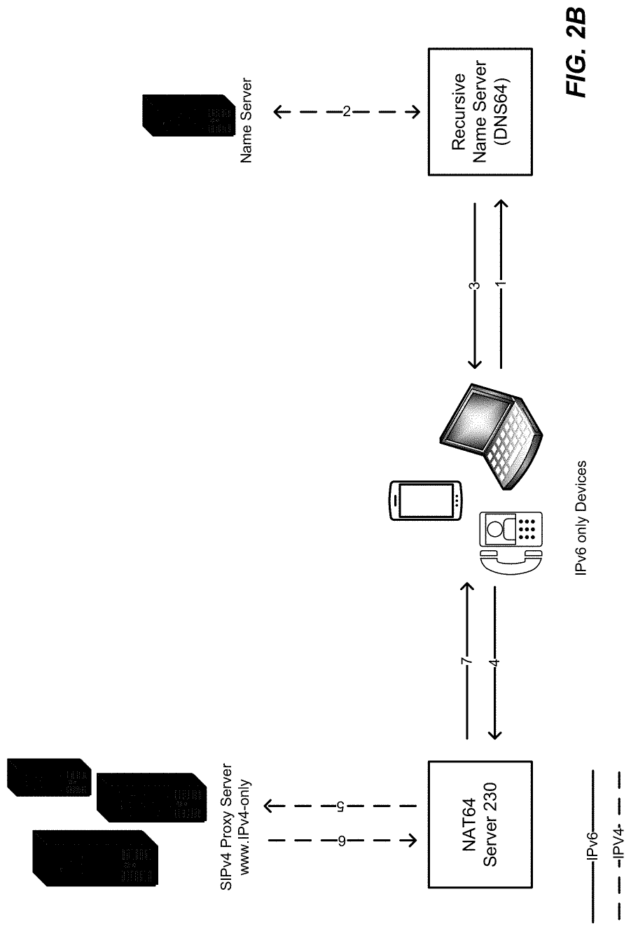

FIG. 2, an illustrative communication system 200 in which connectivity over a single-mode network is described in accordance with at least some embodiments of the present disclosure. The system 200 is shown to include devices 212 and 222, servers 211 and 221, and communication networks 210 and 220. In accordance with at least some embodiments of the present disclosure, the communication networks 210 and 220 may comprise single mode networks and may comprise any type of known communication medium or collection of communication media and may use any type of protocols (e.g., IPv4 or IPv6) to transport messages between communication nodes. The device 212 and the server 211 are single mode clients connected to the single mode network 210. The device 222 and the server 221 are single mode clients connected to the single mode network 220. For example, the communication network 210 may be an IPv6-only network, and the communication network 220 may be an IPv4-only network. The device 212 may need to communicate with the device 222, or the servers 221, via NAT64 230.

The communication networks 210 and 220 may include wired and/or wireless communication technologies. The Internet is an example of a communication networks 210 and 220 that constitutes an Internet Protocol (IP) network consisting of many computers, computing networks, and other communication devices located all over the world. Other examples of communication networks include, without limitation, a standard Plain Old Telephone System (POTS), an Integrated Services Digital Network (ISDN), the Public Switched Telephone Network (PSTN), a LAN, a WAN, a Session Initiation Protocol (SIP) network, a Voice over IP (VoIP) network, a cellular network, an enterprise network, and any other type of packet-switched or circuit-switched network known in the art. In addition, it can be appreciated that the communication networks 210 and 120 need not be limited to any one network type, and instead may be comprised of a number of different networks and/or network types. Moreover, the communication networks 210 and 220 may comprise a number of different communication media such as coaxial cable, copper cable/wire, fiber-optic cable, antennas for transmitting/receiving wireless messages, and combinations thereof. Although, only one network is shown for clarity, in some embodiments, there may be more than one network using the same or different communication protocols.

In some embodiments, the devices 212 and 222 may include a personal communication device. Examples of suitable devices 212 and 222 include, without limitation, a telephone, a softphone, a cellular phone, a multi-speaker communication device (e.g., conference phone), a video phone, a PC, a laptop, a tablet, a PDA, a smartphone, a thin client, or the like. In various embodiments, the servers 211 and 221 may include server computers, cloud computing platforms, data centers, and any physical or virtual computing machine, as well as any variation or combination thereof.

The system 200 is shown to include single mode devices 212 and 222, single mode servers 211 and 221, IPv6-only network 210, and IPv4-only network 220. The device 212 and the server 211 are IPv6-only clients connected to an IPv6 network 210. The device 222 and the server 221 are IPv4-only clients connected to an IPv4 network 220. For example, the device 212 may need to communicate with the device 222, or the servers 221, via NAT64 230 and SIP Proxy 240.

FIG. 2B illustrates the message flow to establish communication between an IPv6-only device and an IPv4-only server. As shown with the (1) arrow from the IPv6-only client to the DNS server, using an IPv6 protocol, the IPv6-only client sends a query for AAAA records for www.IPv4-only to the recursive name server running DNS64. In arrow (2), using the IPv4 protocol, the recursive name server queries the name server for “www.IPv4-only” and gets no AAAA records in response. The recursive name server synthesizes an AAAA record using a prefix and optional suffix and (2) returns the synthesized AAAA record to the IPv6-only client (using IPv6). The IPv6-only client (4) sends IPv6 packet to the synthesized IPv6 address, which is routed to the NAT64 server. The NAT64 server translates the IPv6 packet to the destination IPv4 address (5). The SIPv4 Proxy returns the response over IPv4 to the NAT64 server (6). The NAT64 server converts the packet to IPv6 and returns to the IPv6-only client (7). In this flow, the IPv6-only client is unaware it is communicating with an IPv4-only server.

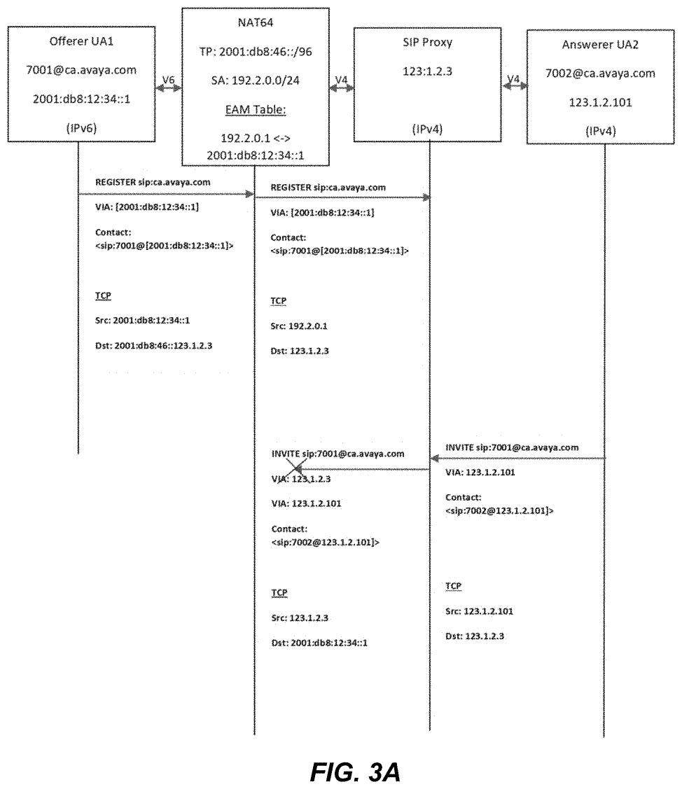

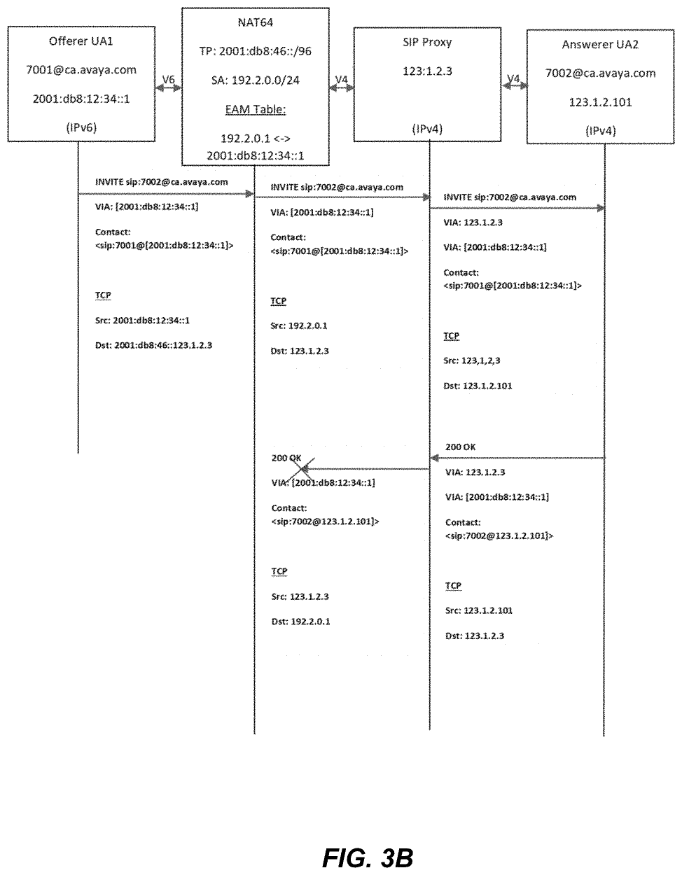

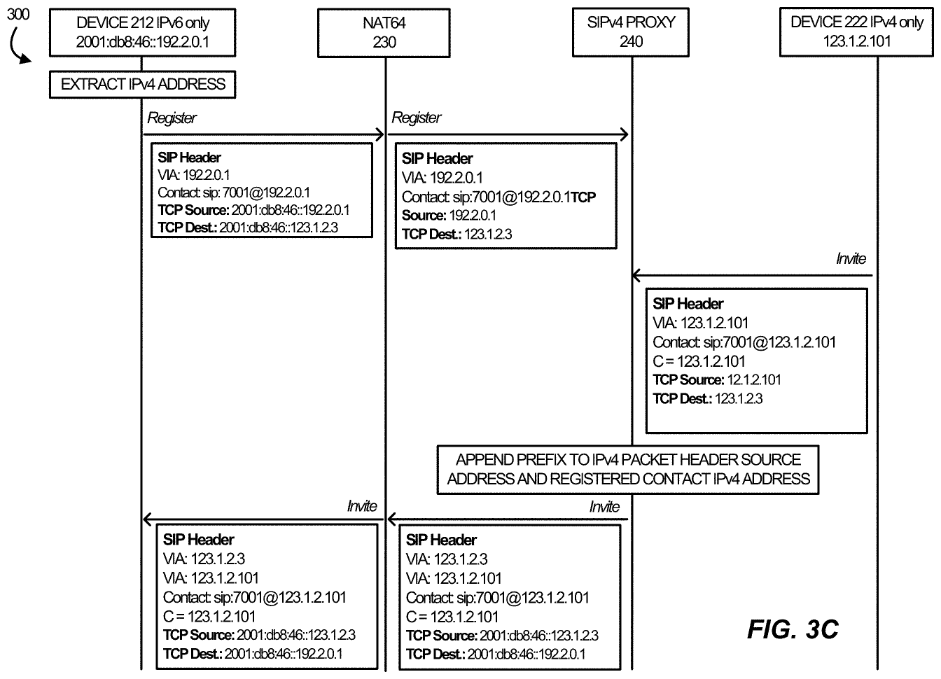

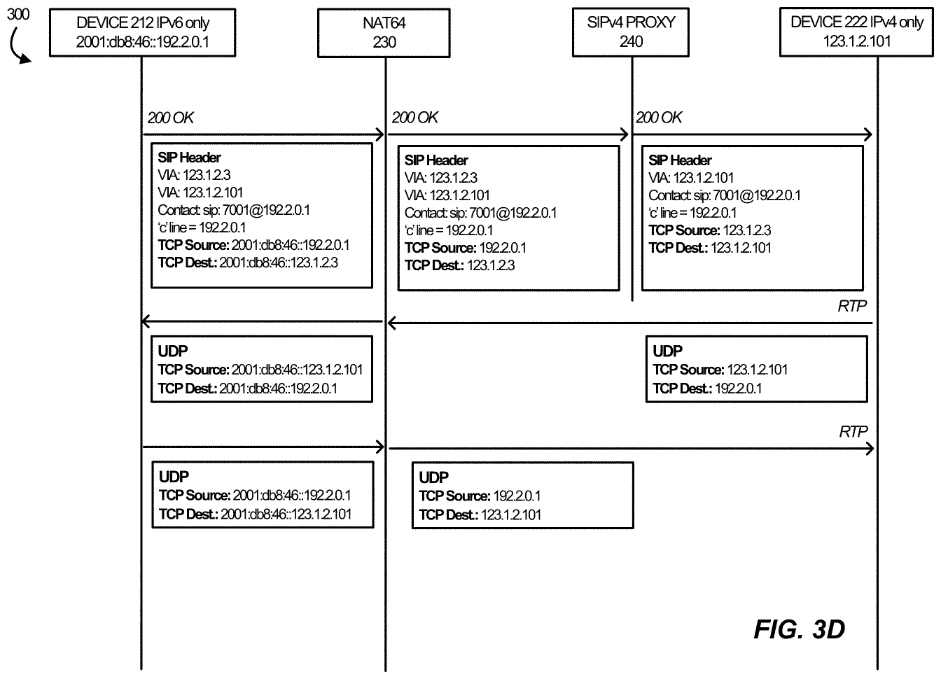

FIGS. 3A-B illustrate the message flow between an IPv6-only device and an IPv4-only device. The contact for the offerer IPv6 is “7001@ca.avaya.com” and the IP address is “2001.db8:12:34::1. The IP address of the answerer IPv4-only device is “123.1.2.101.” The IPv6-only device sends a REGISTER message to the NAT64 server, the VIA lists the IPv6-only device's IP address “VIA: [2001:db8:12:34::1” The Contact header lists the IPv6-only device's contact “Contact”<sip7001@ [2001:db8:12:34::1]>” The source IP address is 2001:db8:12:34::1″ and the destination IP address is “2001:db8:46::123.1.2.3” The NAT64 server transfers the REGISTER message to the SIPv4 Proxy, and the source IP address is rewritten to “192.2.0.1.” When an IPv6-only offeror uses an IPv6 contact address to register with a SIP Proxy (single or dual mode) in an IPv4-only network, and the SIP Proxy sends an INVITE to the Contact IPv6 address over the IPv4-only network, the address cannot be routed to the NAT64 port. In other words, the caller cannot reach the callee.

In another example, illustrated in FIG. 3B, an IPv6-only caller (UA1) provides an IPv6 address as the contact Via header in the INVITE message. The SIP Proxy sends a 200 OK to the contact Via header IPv6 address over the IPv4-only network, and the address cannot be routed to NAT64 port (i.e., 200 OK from callee cannot reach the caller).

FIG. 3C illustrates a message flow for the when the IPv6-only device 212 on an IPv6 network connects to the IPv4-only device 222 on an IPv4-only network via a SIPv4 Proxy. The IPv6-only device 212 determines that the attempted callee device 222 is an IPv4-only device on an IPv4-only network. For example, the IPv6-only device 212 sends a DNS query to the NAT64 230, and the IPv6-only device 212 checks if the returned AAAA record address starts with an IPv6 translation prefix. If the returned AAAA record address does start with the IPv6 translation prefix, the IPv6-only device 212 knows the attempted callee device 222 is an IPv4-only device on an IPv4-only network. Therefore, the IPv6-only device 212 will provide its IPv4 service address in the SIP contact header (for registration) and the SDP ‘c’ line (for direct media). The IPv6-only device 212 is assigned an IPv4 translatable IPv6 address, for example, a service provider's entire IPv4 address space is mapped into an IPv6 translation prefix. In this example, the IPv6-only device 212 has an IPv6 address “2001:db8:46::192.2.0.1,” the “2001:db8:46” portion comprises the IPv6 translation prefix and the “192.2.0.1” portion comprises the IPv4 service address. Therefore, the extracted IPv4 address is 192.2.0.1, which is the address used in the SIP contact header when the IPv6-only device 212 registers with SIPv4 Proxy 240. With the claimed invention, an IPv6-only SIP phone can be IPv4 tolerant and manage an IPv4 service address without an ALG or SBC.

With these changes, an IPv6-only phone can provide its IPv4 service address during registration with SIPv4 Proxy 240 (e.g., FIG. 3C). And an IPv4-only offerer will be able to send an INVITE to an IPv6-only answerer over SIPv4 Proxy 240 (e.g., FIG. 3C). The IPv6-only answerer would know the INVITE comes from the IPv4-only offerer, based on IPv4 address in INVITE Contact header, and will provide its IPv4_SA in 200 OK ‘c’ and ‘m’ lines (e.g., FIG. 3D). The IPv4-only offerer can send media directly to the IPv6-only host using the IPv6 host's service address, IPv4_SA. An IPv6-only offerer can reach an IPv4-only answerer over SIPv4 Proxy 240 and establish direct media via NAT64/46 (e.g. FIG. 3D). For example, an IPv4 tolerant phone uses the extracted IPv4 address in the Via header in the 200 OK message.

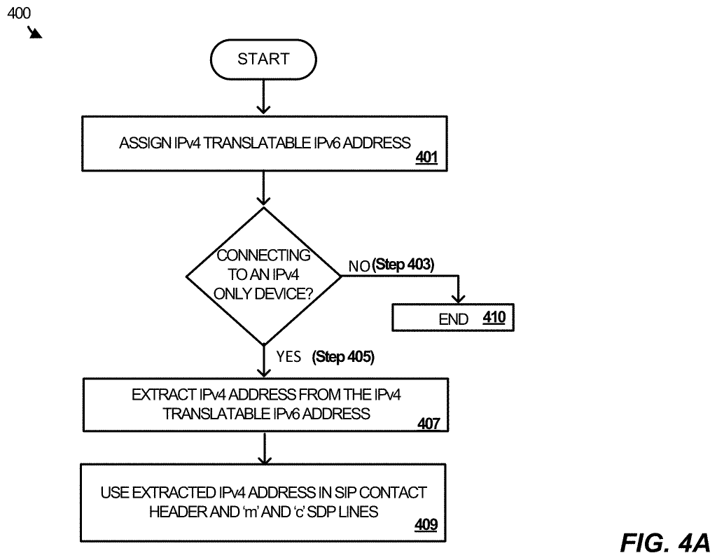

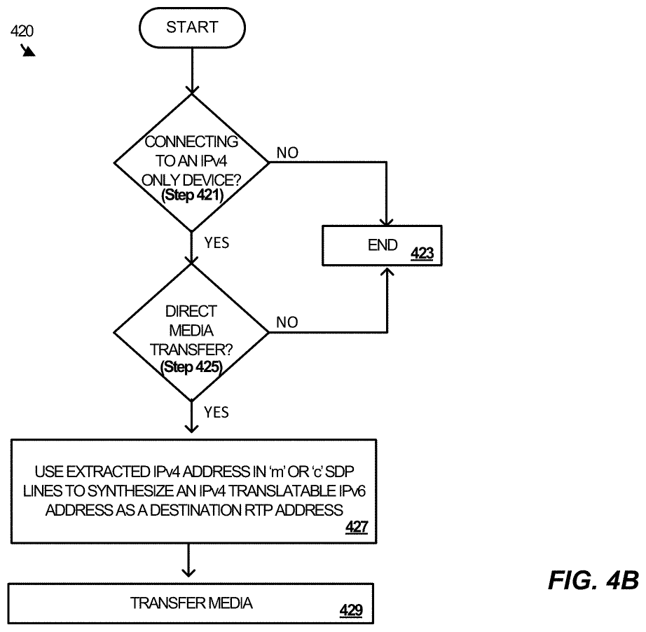

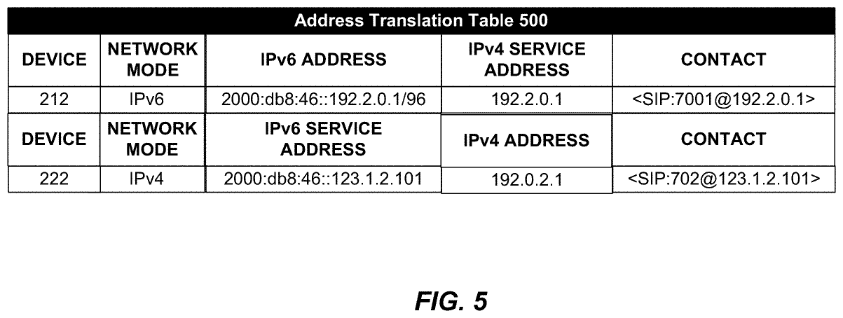

With reference now to FIGS. 4A-4B, additional details of a process 400 for enhancing connectivity between nodes on different single-mode networks will be described in accordance with at least some embodiments of the present disclosure. The processes of operation 400 are referenced parenthetically in the paragraphs that follow.

As illustrated in FIG. 4A, operation 400 to assign an IPv4 Translatable IPv6 address to an IPv6-only device (Step 401). For example, the IPv4 Translatable IPv6 address may be assigned using DHCPv6. The IPv6 Translation Prefix is advertised to the IPv6-only hosts, the translation prefix is needed to extract IPv4 address from the IPv4-translatable IPv6 address. The IPv6-only device on the IPv6-only network determines if it is attempting to connect to an IPv4-only device on an IPv4-only network device. If the IPv6-only device is not connecting to an IPv4-only server or client (NO) (Step 403), the operation 400 ends (Step 410). If the IPv6-only device is connecting to an IPv4-only server or client (YES) (Step 405), then the IPv4 service address is extracted from the IPv4 translatable IPv6 address assigned to the IPv6-only device (Step 407). For example, if the IPv6-only device has the IPv4 translatable IPv6 address: 2001:db8:46::192.2.0.1, the IPv4 service address is 192.2.0.1, which is extracted from 2001:db8:46::192.2.0.1. The IPv6-only host sets 192.2.0.1 as the IPv4_SA in the Via and Contact SIP headers.

When communicating with the IPv4-only servers and clients (i.e., SIPv4 Proxy 240) represented with an IPv4-Translatable IPv6 address, an IPv6-only host has to select its IPv4 service address. The IPv4 service address is derived from the IPv4 translatable IPv6 address (using an NAT64 prefix). The IPv4 service address is set into the Via and Contact SIP headers when talking to the IPv4-only SIP Proxy 240. This ensures IPv4-only servers and clients will get an IPv4 service address from IPv6-only host and their messages will be routed to SIIT.

As illustrated in FIG. 4B, operation 420 transfers media directly between an IPv4-only host on an IPv4-only network and an IPv6-only host on an IPv6-only network. When negotiating a media address, the IPv6-only host will detect whether it talks to IPv4-only host (Step 421). If the IPv6-only host is not talking to an IPv4-only host (NO), the operation 420 ends (Step 423). If the IPv6-only host is talking to an IPv4-only host (YES), for example, the IPv4-only host will only offer an IPv4 address in the INVITE SDP ‘c’ and/or ‘m’ line. The operation 420 proceeds to (Step 425) determine if the IPv6-only host and the IPv4-only host want to transfer media directly. If the IPv6-only host and the IPv4-only host do not want to transfer media directly (NO) the operation 420 ends (Step 423); if (YES) (i.e., the hosts want to transfer media directly), the operation 420 proceeds to (Step 427). In (Step 427), the IPv6-only host will set its IPv4_SA in the ‘c’ line, allowing the IPv4-only host to send media directly to the IPv6-only host, using the IPv6 host's service address, IPv4_SA. The IPv6-only host can also send media directly to the IPv4-only host, by synthesizing an IPv4 host IPv4 translatable IPv6 address as a destination RTP address (Step 427). In (Step 429), media is directly transferred between the IPv4-only host on the IPv4-only network and the IPv6-only host on the IPv6-only network. Since the IPv6-only device extracts the IPv4 address from the IPv4 translatable IPv6 address and sets SIPv6 headers, ‘m’ and ‘c’ SDP lines itself, using IPv4_SA, there is no need for the ALG/SBC server.

The IPv6 only host sends media, RTP, and RTCP to the NAT64 translator using the IPv4-translatable IPv6 address. For example, the NAT64 may extract the IPv4 destination address from a UDP destination address, by removing the translation prefix part of the destination address, and sends RTP to the IPv4-only host. The IPv6-only phone will synthesize an IPv4 translatable IPv6 address for the RTP destination. When an IPv6-only host sends media, RTP and RTCP, to NAT64 XLAT, using the IPv4-translatable IPV6 address, the NAT64 extracts IPv4 destination address and sends RTP to IPv4-only host. If an INVITE comes from (n4) the IPv4-only host, with an IPv4 address in the SDP ‘m’ and ‘c’ lines, (n6) the IPv6-only host takes the IPv4 address from ‘m’ line, adds the translation prefix, and sends RTPv6 packets to the NAT64, using an IPv4 translatable IPv6 address as the UDP packet destination address (IPv6 service address is a translation prefix+IPv4 address in ‘c’ line). The IPv6-only host (n6) creates an IPv6 service address for media to (n4) the IPv4-only host and an IPv4 service address for registration to SIPv4 proxy.

FIG. 5 illustrates an example of an address translation table 500 in accordance with the embodiments described herein, although other data formats are possible and in accordance with the embodiments described herein.

Address Translation Table 500 comprises the fields/columns “DEVICE,” “NETWORK MODE,” “IPv6 ADDRESS,” “IPv4 ADDRESS,” and “CONTACT.” The columns listed in Address Translation table 500 are for illustrative purposes only, and not all columns are required, additionally, the table may include other columns not listed in this example.

For example, NAT64 230 may generate the address translation table 500.

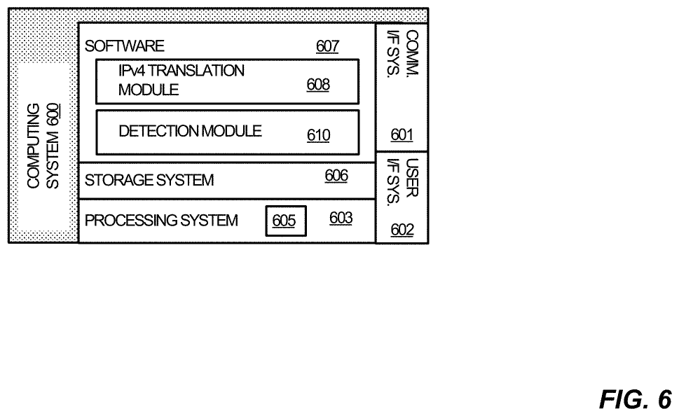

FIG. 6 illustrates a computing system 600 used to enhance connectivity to between single-mode nodes connected to different single mode networks as described herein, according to one implementation. Similar computing systems may be included in the Clients, Hosts, and routers described herein.

The computing system 600 is representative of any computing system or systems with which the various operational architectures, processes, scenarios, and sequences disclosed herein for providing a communication service and selecting media paths may be implemented.

The computing system 600 is an example of the single mode devices 112, 122, 212, and 222, and the servers 111, 121, 211, and 221, although other examples may exist. The computing system 600 comprises a communication interface 601, a user interface 602, and a processing system 603. The processing system 603 is linked to the communication interface 601 and the user interface 602. The processing system 603 includes a microprocessor and/or processing circuitry 605 and a memory device 606 that stores operating software 607. The computing system 600 may include other well-known components such as a battery and enclosure that are not shown for clarity. The computing system 600 may comprise a server, a user device, a desktop computer, a laptop computer, a tablet computing device, or some other user communication apparatus.

The communication interface 601 comprises components that communicate over communication links, such as network cards, ports, radio frequency (RF), processing circuitry and software, or some other communication devices. The communication interface 601 may be configured to communicate over metallic, wireless, or optical links. The communication interface 601 may be configured to use SIP, TCP, UDP, Time Division Multiplex (TDM), Internet Protocol (IP), Ethernet, optical networking, wireless protocols, communication signaling, or some other communication format—including combinations thereof. In some implementations, the communication interface 601 is configured to communicate with other end user devices, wherein the communication interface is used to transfer and receive voice communications for the devices.

The user interface 602 comprises components that interact with a user to receive user inputs and to present media and/or information. The user interface 602 may include a speaker, microphone, buttons, lights, display screen, touch screen, touch pad, scroll wheel, communication port, or some other user input/output apparatus—including combinations thereof. The user interface 602 may be omitted in some examples.

The processing circuitry 605 comprises a microprocessor and other circuitry that retrieves and executes operating the software 607 from the memory device 606. The memory device 606 may include volatile and nonvolatile, removable and non-removable media implemented in any method or technology for storage of information, such as computer readable instructions, data structures, program modules, or other data. The memory device 606 may be implemented as a single storage device, but may also be implemented across multiple storage devices or sub-systems. The memory device 606 may comprise additional elements, such as a controller to read the operating software 607. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

The processing circuitry 605 is typically mounted on a circuit board that may also hold the memory device 606 and portions of the communication interface 601 and the user interface 602. The operating software 907 comprises computer programs, firmware, or some other form of machine-readable program instructions. The operating software 607 includes an IPv4 translation module 608 and a detection module 610, although any number of software modules within the application may provide the same operation. The operating software 607 may further include an operating system, utilities, drivers, network interfaces, applications, or some other type of software. When executed by the processing circuitry 605, the operating software 607 directs the processing system 603 to operate the computing system 600 as described herein.

In at least one implementation, the IPv4 translation module 608, when read and executed by the processing system 603, directs the processing system 603 to extract an IPv4 address from an IPv4 translatable IPv6 address assigned to an IPv6-only device. In some embodiments, the IPv4 translation module 608, when read and executed by the processing system 603, directs the processing system 603 to append an IPv6 prefix to an IPv4 address for IPv4 only to IPv6 only. For example, the IPv6 prefix may be appended to the IPv4 packet header source address and the registered contact IPv4 address. In at least one implementation, the detection module 610, when read and executed by the processing system 603, directs the processing system 603 to determine that the destination of a communication is an IPv4-only device on an IPv4-only network.

It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of operating an IPv6-only client to conduct a SIP (Session Initiation Protocol) communication session with an IPv4-only server or client, the method comprising:
assigning the IPv6-only client an IPv4-translatable IPv6 Internet Protocol (IP) address;
determining the IPv6-only client is initiating the SIP communication session with the IPv4-only server or client;
extracting an IPv4 IP address from the IPv4 translatable IPv6 IP address; and
providing the extracted IPv4 address in a SIP header of IPv6 packets.

2. The method of claim 1, further comprising:
using the extracted IPv4 address in ‘m’ and ‘c’ SDP LINES as a destination Real-time Transport Protocol (RTP) address.

3. The method of claim 1, further comprising:
registering with a SIP IPv4-only Proxy using the extracted IPv4 IP address.

4. The method of claim 1, further comprising:
using the IPv4 translatable IPv6 IP address for TCP.

5. The method of claim 1, wherein determining the IPv6-only client is initiating the SIP communication session with the IPv4-only server or client comprises performing a DNS query for a SIPv4 Proxy FQDN and receiving AAAA records in response, and wherein the AAAA records start with an IPv6 translation prefix.

6. The method of claim 1, wherein extracting the IPv4 IP address from the IPv4 translatable IPv6 IP address comprises:
determining a translation prefix; and
extracting the IPv4 IP address from the IPv4 translatable IPv6 IP address using the determined translation prefix.

7. The method of claim 1, wherein using the extracted IPv4 IP address in the SIP header comprises using the extracted IPv4 IP address in a Via header and a contact header.

8. The method of claim 1, further comprising:
the IPv6-only client and the IPv4-only server or client transmitting media directly using UDP.

9. An IPv6-only client conducting a SIP (Session Initiation Protocol) communication session with an IPv4 only server or client, the IPv6-only client comprising:
a processor configured to determine the SIP communication session is with the IPv4-only server or client;
the processor configured to extract an IPv4 IP address from the IPv4-translatable IPv6 IP address; and
a communication interface configured to provide the extracted IPv4 IP address in a SIP header of IPv6 packet.

10. The IPv6-only client of claim 9, further comprising:
the communication interface configured to use the extracted IPv4 address in ‘m’ and ‘c’ SDP LINES as a destination Real-time Transport Protocol (RTP) address.

11. The IPv6-only client of claim 9, further comprising:
the communication interface configured to register with a SIP IPv4-only Proxy using the extracted IPv4 IP address.

12. The IPv6-only client of claim 9, further comprising:
the communication interface configured to use the IPv4 translatable IPv6 IP address for TCP.

13. The IPv6-only client of claim 9, wherein the communication interface configured to perform a DNS query and receives AAAA records in response, and wherein the AAAA records start with an IPv6 translation prefix.

14. The IPv6-only client of claim 9, wherein the processor is further configured to:
determine a translation prefix; and
extract the IPv4 IP address from the IPv4-translatable IPv6 IP address using the determined translation prefix.

15. The IPv6-only client of claim 9, wherein the communication interface is configured to use the extracted IPv4 IP address in a Via header and a contact header.

16. A computer-readable medium comprising processor-executable instructions comprising:
instructions configured to conduct a SIP (Session Initiation Protocol) communication session between an IPv6-only client and an IPv4-only server or client;
instructions configured to determine the IPv6-only client is initiating the SIP communication session with the IPv4-only server or client;
instructions configured to extract an IPv4 IP address from the IPv4-translatable IPv6 IP address; and
instructions configured to provide the extracted IPv4 IP address in a SIP header of IPv6 packets.

17. The computer-readable medium of claim 16, further comprising:
instructions configured to use the extracted IPv4 address in ‘m’ and ‘c’ SDP LINES as a destination Real-time Transport Protocol (RTP) address.

18. The computer-readable medium of claim 16, further comprising:
instructions configured to use the IPv4 translatable IPv6 IP address for TCP

19. The computer-readable medium of claim 16, further comprising:
instructions configured to register with a SIP IPv4-only Proxy using the extracted IPv4 IP address.

20. The computer-readable medium of claim 16, further comprising:
instructions configured to determine a translation prefix; and
instructions configured to extract the IPv4 IP address from the IPv4-translatable IPv6 IP address
instructions configured to use the determined translation prefix.
